(19) United States
(12) Patent Application Publication
(10) Pub. No.: US 2012/0312904 A1
(43) Pub. Date: Dec. 13, 2012

(54) FLEXIBLE AUXILIARY NOZZLE CARRIER

(75) Inventors: Jerry D. Lawyer, Clermont, FL (US); Donald E. Smith, Winter Springs, FL (US)

(73) Assignee: SENNINGER IRRIGATION INC., Clermont, FL (US)

(21) Appl. No.: 13/591,432

(22) Filed: Aug. 22, 2012

Related U.S. Application Data
(62) Division of application No. 12/653,963, filed on Dec. 22, 2009.
Application No. 12/653,963 is a continuation-in-part of application No. 12/215,661, filed on Jun. 30, 2008.

(51) Int. Cl. B05B 15/06; A01G 25/00

(52) U.S. Cl. 239/600

(57) ABSTRACT

An irrigation sprinkler head has an auxiliary nozzle carrier having a nozzle attached to each end thereof. Each nozzle is held on one end of the flexible nozzle carrier. One end of the nozzle carrier holding a nozzle is attached to the sprinkler head to operatively attach the nozzle to the outlet of the sprinkler head while the other end extends from the side of the sprinkler head. The nozzles are rapidly exchanged on the sprinkler head by disconnecting the nozzle carrier and nozzle from the sprinkler head and connecting the other end of the nozzle carrier and nozzle to the sprinkler head without removing either nozzle from the carrier and without the use of tools. The nozzle carrier is flexible and angled between the nozzle holding ends so that the nozzle carrier can flex between the ends thereof to absorb impact without damage when used below a crop line.

This application is a division of prior U.S. patent application Ser. No. 12/653,963, filed Dec. 22, 2009 for Flexible Auxiliary Nozzle Carrier, which is a continuation-in-part of prior U.S. patent application Ser. No. 12/215,661, filed Jun. 30, 2008 for a Quick Change Nozzle.

### BACKGROUND OF THE INVENTION

The present invention relates to an irrigation sprinkler head flexible auxiliary nozzle carrier for supporting a plurality of nozzles held on a sprinkler head by one of the nozzles being operatively attached to the sprinkler head. The nozzle carrier is flexible and resilient between the ends thereof and absorbs impact without damage allowing the sprinkler head to be used below a crop line.

A variety of irrigation systems are used throughout the world or irrigating crops and groves. One common system used for irrigation is a sprinkler system having a plurality of sprinkler heads coming from a central water supply line for distributing water over a surface area. These systems may use a moving supply line for irrigating food crops, groves and the like. The sprinkler units typically have replaceable nozzles so that different nozzles may be selected and mounted in the sprinkler unit to achieve a desired range or rate of coverage or simply to replace a defective nozzle. An irrigation system may also have many different sprinkler units of the same type with each having different nozzles and it is sometimes desirable and necessary to change the nozzles often for a given area to obtain an optimum irrigation of an area of coverage. This requires maintaining different sprinkler nozzles and selecting the nozzle for a particular coverage after a sprinkler system is installed. Many current nozzles are removably attached to a sprinkler head in which the nozzle or a cover for the nozzle is threadedly attached which requires unscrewing a nozzle or cap for the nozzle, finding a replaceable nozzle, and attaching the new nozzles onto the sprinkler unit. This is sometimes difficult because the nozzle is positioned so it cannot be gripped easily to unscrew the nozzle or to simply pull out the nozzle in the case of a press-fitted nozzle. It is also necessary to have a replacement nozzle handy for exchanging nozzles on the sprinkler head.

In Applicant's prior U.S. patent application Ser. No. 12/215,661, filed Jun. 30, 2008, for a Quick Change Nozzle an irrigation sprinkler has a rapid change nozzle which can be snapped-in from the side of the sprinkler outlet and then quickly unsnapped and removed.

Other prior art removable sprinkler nozzles may be seen in the McKenzie U.S. Pat. No. 5,234,169 for a removable sprinkler nozzle in which the nozzle fits in a recessed seat and has a rotatable upper cover and a camming surface formed on the cover which extends down into engagement with the nozzle. The cam surface is shaped to push the nozzle at least partially out of its seat during rotation of the cover to allow a user to be able to grip the nozzle and complete its removal by pulling outward on the nozzle. The cover also includes a locking rib which can be brought to bear against the nozzle when the nozzle is fully received in its seat to help retain the nozzle in place. In the Scott et al. U.S. Pat. No. 5,699,962, a sprinkler unit has a nozzle in which the sprinkler body has an outlet having a nozzle receiving socket for a removable nozzle mounted in the sprinkler outlet. The lodging device in the socket is used for latching engagement with the nozzle for retaining the nozzle in the socket. In the Hart U.S. Pat. No. 3,799,453, a quick disconnect nozzle for an irrigation sprinkler is fitted with a screw threaded connection to the sprinkler outlet. The Anuskiewicz U.S. Pat. No. 6,871,795 is an irrigation sprinkler with an easily removable nozzle.

The present invention relates to an irrigation sprinkler system in which a nozzle attached to a sprinkler head needs to be exchanged for another size nozzle at some time during the growing season. In a typical irrigation system sprinkler heads with one or more auxiliary nozzles, the sprinkler head carries two or more nozzles in a rigid nozzle carrier. While one nozzle in the carrier is being utilized by the sprinkler, an alternate nozzle is held off to the side, out of the water spray. To change the nozzle, the nozzle that was being used is removed from the sprinkler, the nozzle carrier is flipped around and a new nozzle is installed into the sprinkler. The nozzle is held off to the side, out of the spray, but the nozzle and carrier are vulnerable to damage.

Sprinklers mounted on flexible drops from a central water line are also prone to blowing around in high winds. This random movement allows the sprinklers to impact one another and the support structure itself. If the alternate nozzle or the nozzle carrier is struck, the nozzle and/or nozzle carrier can get damaged or broken off and lost. In addition these sprinklers are often dragged through taller crops and if the carrier gets hooked on a plant, it will break the carrier and the alternate nozzle will be lost. Sprinklers can also be dragged along the ground when a field has high and low spots. If a rigid carrier and nozzle system impacts something hard or gets hooked on a plant and pulled, the sprinkler itself can be unscrewed and lost.

The present invention prevents damage to the carrier, loss of the alternate nozzle(s) and the unwanted unscrewing of the sprinkler. The flexible carrier prevents damage to the nozzle carrier itself and reduces the chance that the working nozzle will become dislodged by impact or contact with other sprinklers, center pivot structures, or crops.

One prior art auxiliary nozzle holder can be seen in U.S. Pat. No. 5,762,269, to Sweet, for a Nozzle Clip. The nozzle clip holds two nozzles, one of which is connected to an adapter on the sprinkler head for receiving a quick change nozzle. The clip is reversible such that the first and second nozzles are selectively mounted on the adapter.

The present invention relates to an auxiliary nozzle carrier for carrying an extra sprinkler nozzle for an irrigation sprinkler capable of absorbing impact without damage while being able to deflect away from obstacles rather than becoming damaged by them.

### SUMMARY OF THE INVENTION

An auxiliary nozzle carrier is provided for a sprinkler head for holding a second or plurality of nozzles to the sprinkler head. The auxiliary nozzle carrier can hold any number of nozzles desired. The nozzle carrier body has two end portions spaced by a generally stepped or offset center portion. Each end portion has means for attaching a nozzle thereto. The generally stepped or offset center portion is flexible and resilient so that an attached nozzle or nozzles can move relative to another attached nozzle so that contact with one nozzle flexes the nozzle carrier to prevent damage to the nozzle carrier or other nozzle. Each nozzle is held to one end portion of the nozzle carrier by a specially shaped opening or window for retaining the nozzle. The nozzle carrier may be made of an elastomer or rubber or may be a living hinge.

A sprinkler having an auxiliary nozzle carrier and two or more nozzles each having a sprinkler housing having a housing passageway therethrough having an inlet for connecting to a source of water and an outlet therefrom. The sprinkler head may have an outlet having a side window for inserting a rapid change nozzle from the side of the housing passageway. The auxiliary nozzle carrier has two end portions, with each end portion being offset from the other end portion and each end portion having a nozzle attached thereto. Each nozzle has a nozzle passageway therethrough, and is attached to the housing to axially align the housing passageway and with a nozzle passageway. Each nozzle has attaching means for removably attaching the nozzle to the housing. Any one of the nozzles attached to the auxiliary nozzle carrier can be attached to the sprinkler housing while holding the other nozzle or nozzles in the auxiliary nozzle carrier to the sprinkler. One nozzle can be rapidly exchanged with another nozzle on the sprinkler head by disconnecting one from the sprinkler head, and connecting the other to the sprinkler without removing a nozzle from said nozzle carrier.

### BRIEF DESCRIPTION OF THE DRAWINGS

Other objects, features, and advantages of the present invention will be apparent from the written description and the drawings in which:

FIG. 1 is a perspective view of an auxiliary nozzle carrier in accordance with the present invention;

FIG. 2 is an exploded perspective view of auxiliary nozzle carrier of FIG. 1 having a nozzle being attached thereto;

FIG. 3 is a perspective view of the auxiliary nozzle carrier of FIGS. 1 and 2 having a pair of nozzles attached thereto;

FIG. 4 is a side elevation of the auxiliary nozzle carrier of FIG. 3 showing the flexing thereof in phantom;

FIG. 5 is a perspective view of an irrigation sprinkler head having the auxiliary nozzle carrier supporting an auxiliary nozzle;

FIG. 6 is a partial sectional view of a sprinkler head having a nozzle supported on the nozzle carrier being attached thereto; and

FIG. 7 is a partial sectional view of the sprinkler head of FIG. 6 having a nozzle and nozzle carrier and auxiliary nozzle mounted therein.

### DESCRIPTION OF THE PREFERRED EMBODIMENT

The present invention relates to an irrigation sprinkler head flexible auxiliary nozzle carrier for supporting two or more nozzles held on a sprinkler head by one of the nozzles being operatively attached to the sprinkler head.

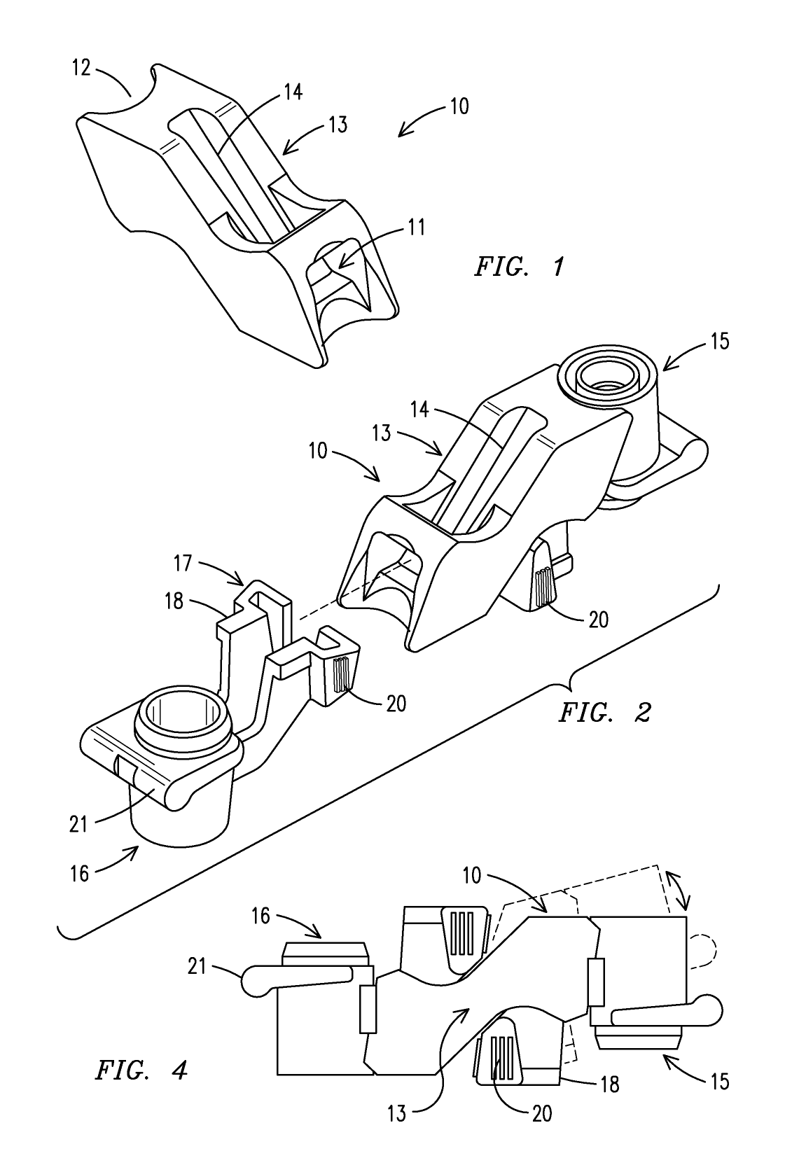

Referring to the drawings FIGS. 1 through 4, a flexible nozzle carrier 10 can be seen having openings or passageways 11 and 12. The openings are identical except for one being upside down from the other. The carrier has an offset or stepped and angled flexible area 13 between the ends thereof which has an enlarged groove 14. The flexible nozzle carrier 10 has a nozzle 15 mounted in one end thereof and a nozzle 16 mounted in the other end thereof. The nozzles 15 and 16 can be seen to be mounted upside down from each other.

Each nozzle has a pair of latching arms 17 having a pair of snap tabs 18, which arms have been inserted through the carrier 10 opening 11 for one nozzle and the opening 12 for the other nozzle. Each handle section has a gripping portion 20 so that the arms 17 protruding through the openings 11 and 12 in the nozzle carrier 10 may be squeezed together. Each nozzle 15 and 16 has a tongue 21 protruding therefrom used for mounting the nozzle to a sprinkler head. The offset or stepped area 13 advantageously places the auxiliary nozzle out of the way of the water spray from the sprinkler head by the angle of the offset area 13 set to raise the level of the auxiliary nozzle. It should, however, be clear that any other type of nozzle, such as a threadedly attached nozzle can be supported on the auxiliary nozzle without departing from the spirit and scope of the invention.

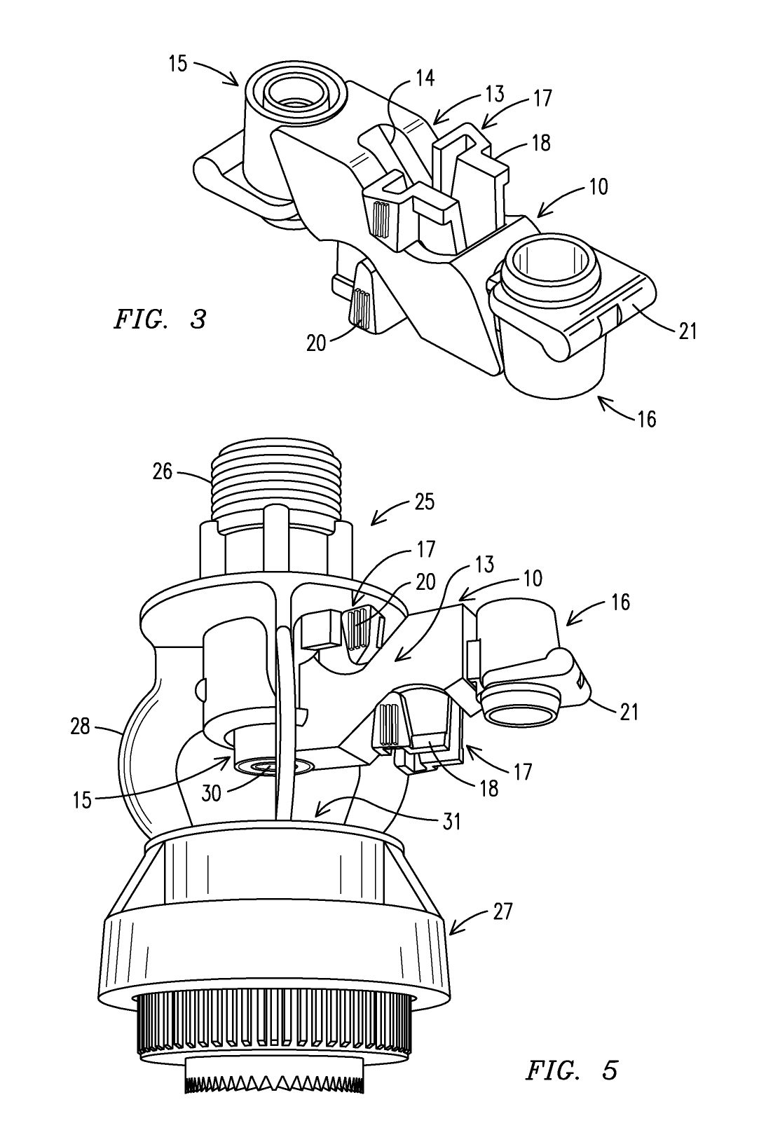

As seen in FIG. 4, a sprinkler head 25 has a threaded connector 26 for attaching to a water source for water to pass through the sprinkler head 25. The sprinkler head 25 has a water dispersion portion 27 supported by a plurality of arms 28 and has a nozzle 15 mounted therein and supporting a flexible nozzle carrier 10 supporting an auxiliary nozzle 16 on the opposite end of the nozzle carrier 10 from the nozzle 15. The nozzle carrier 10 is made of a flexible and resilient material or can be made with a living hinge to allow flexibility to the stepped or angled portion 13 of the carrier 10. This allows the flexible nozzle carrier 10 to flex if something hits the auxiliary nozzle 16 in FIG. 5 causing it to flex, as shown in the phantom view in FIG. 4. This prevents the auxiliary nozzle 15 from being damaged when struck by an object and, at the same time, prevents the nozzle 15 from being knocked loose from the sprinkler head 25.

The sprinkler head 25 can be dragged through tall crops where it is constantly being hooked on other plants where the nozzle 15 auxiliary nozzle 16 can be knocked loose from a carrier. The sprinkler can also be dragged along the ground when the field has high and low spots without the auxiliary nozzle being knocked loose or the nozzle being knocked from the sprinkler head. In addition, sprinklers mounted on flexible drops on center pivot supply lines and the like are prone to blowing around in high winds and randomly impact one against another. The present auxiliary nozzle carrier will flex whenever the auxiliary nozzle catches on a plant or is struck by an object or another sprinkler.

The angled offset flexible center portion of the carrier 10 is angled to raise the auxiliary nozzle above the water being sprayed or distributed by the sprinkler head 25 as the water passes through the opening 30 of the nozzle 15 and impinges upon the water distribution surface 31. The nozzle carrier 10 can be made of any strong flexible material, such as rubber or a flexible elastomer.

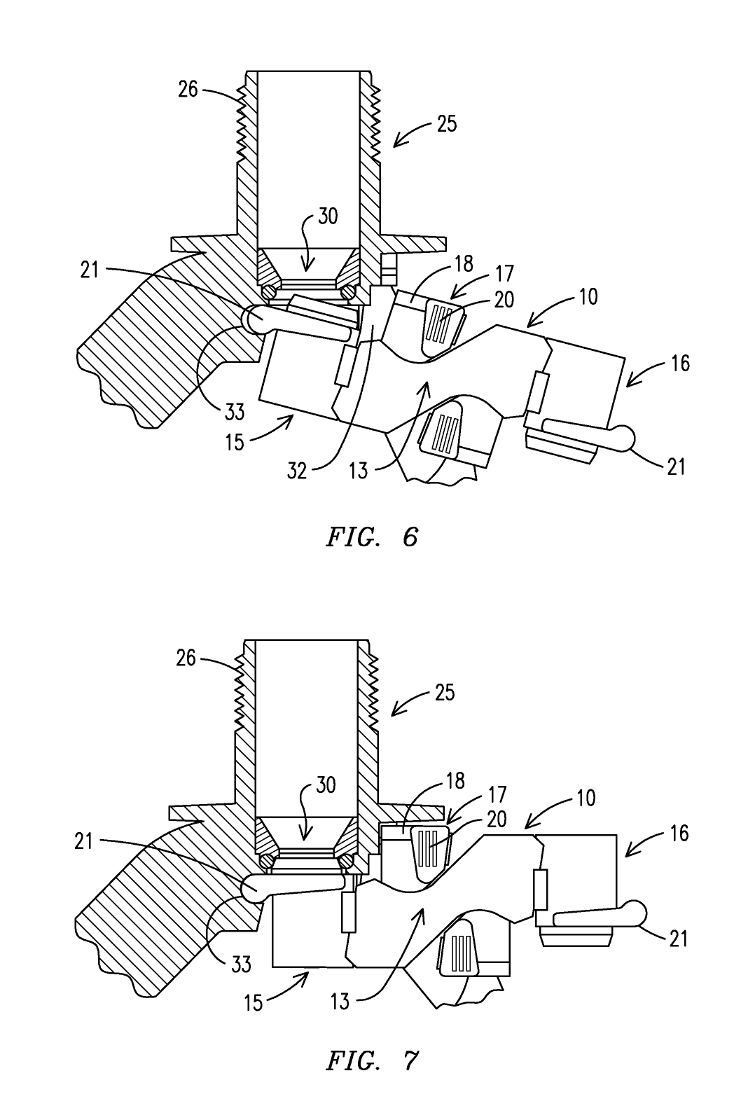

The mounting of a nozzle having the auxiliary nozzle carrier attached is seen in FIGS. 6 and 7. The water outlet 30 of the nozzle sprinkler body 25 has a side opening or window 32 for inserting the nozzle 15. The sprinkler head 25 has a recessed area 33 on the opposite side of the body from the window 32. Latching members 34 are formed on the sprinkler body 25 adjacent to and above the side window 32. The tongue 21 may be of a rounded shape and is sized to fit in the recessed area 33 of the sprinkler head body. The pair of arms 17 on the nozzle 15 has a pair of snap connectors or latching members 18 for engaging the sprinkler body latching members 34.

In operation, the nozzle 15, as seen in FIGS. 6 and 7, can be grasped by handles 20 on the arms 17 for inserting the nozzle 15 through the side window 32 and the tongue 21 inserted into the recess 33 of the sprinkler head allowing the nozzle 15 to be rotated with a lever action on the tongue 21 in the recess 33. Arms 17 are pressed together to move a pair of snap tabs 18 inward towards each other where they can be snapped into position so that when the handles are released, the nozzle is locked in place, aligning the passageway of nozzle 15 with the outlet of the sprinkler head 25. The nozzle arms 17 are squeezed together for disengaging the latching mechanism for nozzle removal.

It should be clear at this time that an auxiliary nozzle carrier for an irrigation sprinkler has been provided which is capable of absorbing impact without damage and which is able to deflect away from obstacles to avoid damage. The auxiliary nozzle carrier is both flexible and tear resistant. However, the present invention is not to be construed as limited to the forms shown which is to be considered illustrative rather than restrictive.

We claim:

1. A sprinkler having an auxiliary nozzle carrier having a pair of nozzles comprising:
a sprinkler housing having a housing passageway therethrough having an inlet for connecting to a source of water and an outlet therefrom, said outlet having a side window for inserting a nozzle from the side of said housing passageway;
an auxiliary nozzle carrier having an angled flexible center portion having two ends and having two end portions, one end portion attached to each end of said angled flexible center portion, and each end portion having a nozzle mounted thereto, said angled flexible center portion holding said two end portions in a generally parallel plane to each other by a predetermined distance, said angled flexible center portion being shaped to allow flexing thereof and movement of one auxiliary nozzle carrier end portion relatively to said sprinkler housing when attached to said sprinkler housing, each said nozzle having a nozzle passageway therethrough, and being shaped to fit through said housing side window and axially aligned with said housing passageway, said auxiliary nozzle carrier having latching means for removably latching one end portion of said auxiliary nozzle carrier to said sprinkler housing to allow said auxiliary nozzle carrier angled flexible center portion and other end portion to extend form said sprinkler housing thereby allow said auxiliary nozzle carrier angled flexible center portion to flex relative to said sprinkler housing;
whereby a sprinkler has an auxiliary nozzle carrier having an angled flexible center portion having one nozzle attached in said sprinkler housing while flexible holding a second nozzle therein adjacent said sprinkler housing to absorb impact without second nozzle damage.

2. The sprinkler having an auxiliary nozzle carrier having a pair of nozzles in accordance with claim 1 in which each said auxiliary nozzle carrier end portion is removable attached to one end of said angled flexible center portion.

3. The sprinkler having an auxiliary nozzle carrier having a pair of nozzles in accordance with claim 2 in which said auxiliary nozzle carrier center portion has an opening in each end thereof for removable attaching one said end portion into each said opening.

4. The sprinkler having an auxiliary nozzle carrier having a pair of nozzles in accordance with claim 3 in which each said auxiliary nozzle carrier end portion has a nozzle mounted thereto.

5. The sprinkler having an auxiliary nozzle carrier having a pair of nozzles in accordance with claim 4 in which said auxiliary nozzle carrier latching means includes a pair of spaced arms each having a tab thereon for engaging said sprinkler housing adjacent said side window to removably latch said auxiliary nozzle carrier end portion to said sprinkler housing.

6. The sprinkler having an auxiliary nozzle carrier having a pair of nozzles in accordance with claim 5 in which said auxiliary nozzle carrier latching means includes a pair of spaced arms on each end portion and having a tab thereon for engaging said angled flexible center portion and said sprinkler housing adjacent said side window to removably latch one end portion of said auxiliary nozzle carrier to said angled flexible center portion and to said sprinkler housing.

7. The sprinkler having an auxiliary nozzle carrier having a pair of nozzles in accordance with claim 6 in which sprinkler housing has a pair of spaced protrusions adjacent said outlet side window for engaging said end portion tabs.

8. The sprinkler having an auxiliary nozzle carrier having a pair of nozzles in accordance with claim 7 in which each end of said angled flexible center portion has an opening therein shaped to hold one said auxiliary nozzle carrier end portion therein.

9. The sprinkler having an auxiliary nozzle carrier having a pair of nozzles in accordance with claim 7 in which each end of said auxiliary nozzle carrier angled flexible center portion has an opening therein shaped for holding one said auxiliary nozzle carrier end portion nozzle upside down from the other said angled flexible center portion end whereby said auxiliary nozzle carrier can be disconnected from said sprinkler head and rotated to attach the other said end portion and nozzle to said sprinkler housing.

10. The sprinkler having an auxiliary nozzle carrier having a pair of nozzles in accordance with claim 9 in which said nozzle carrier angled flexible center portion is made of a flexible elastomer.

11. The sprinkler having an auxiliary nozzle carrier having a pair of nozzles in accordance with claim 10 in which said angled flexible nozzle carrier has a living hinge between the end portions thereof.
